(19) United States
(12) Patent Application Publication
(10) Pub. No.: US 2015/0368502 A1
(43) Pub. Date: Dec. 24, 2015

(54) METHOD FOR COATING A SUBSTRATE WITH A POLY(IONIC-LIQUID) AND COATED SUBSTRATE MADE BY THE PROCESS

(71) Applicant: SURFACE INNOVATIONS LIMITED, Oxforshire (GB)

(72) Inventors: Jas Pal Singh Badyal, Durham (GB); Thomas J. Wood, Durham (GB)

(21) Appl. No.: 14/409,034

(22) PCT Filed: Jun. 27, 2013
(86) PCT No.: PCT/GB2013/051702

§ 371 Date: Dec. 18, 2014

(30) Foreign Application Priority Data
Jun. 27, 2012 (GB) 1211393.2

(51) Int. Cl. C09D 139/04; B05D 1/00

(52) U.S. Cl. CPC C09D 139/04; B05D 1/62

(57) ABSTRACT

A method for the production of substrate coated with a poly(ionic liquid), which method comprises the steps of: •(i) providing a monomer (I) which comprises both a polymerisable functional group and a nitrogen centre; •(ii) providing a substrate; •(iii) contacting the substrate with the monomer (I) in an exciting medium, in order to cause polymerisation of the monomer and deposition of the resultant precursor polymer (II) on the substrate; and •(iv) subsequently contacting the precursor polymer (II) with a cation-generating agent, in order to convert it into a poly(ionic liquid) (III) containing an imidazolium cation.

### FIELD OF THE INVENTION

This invention relates to a method for the production of a poly(ionic liquid), and to a poly(ionic liquid) produced using the method.

### BACKGROUND TO THE INVENTION

Ionic liquids are organic salts which are liquid at or near to room temperature. They arise from combinations of suitable ions, in which the lattice energy and melting point are abnormally low. They may for instance comprise bulky, asymmetrical, charge-delocalised ions, which associate relatively weakly and with a low degree of structural order. Thus, ionic liquids typically include bulky organic cations such as ammonium [1, 2], imidazolium [3] or phosphonium [4] cations, along with appropriate counterions. Alternatively, an ionic liquid can comprise zwitterions, which carry both a positive and a negative charge on the same molecule.

Ionic liquids can possess a number of remarkable properties, including negligible vapour pressure, high solubilising power and a broad liquid temperature range, which have rendered them interesting alternatives to conventional liquids in a variety of applications.

Poly(ionic liquid)s can be manufactured from ionic liquids carrying polymerisable moieties such as acrylate or vinyl groups, and can have the advantage of superior mechanical properties [5]. Like their monomeric counterparts, they have found application in chromatography [6], gas separation [7] and carbon dioxide absorption [8], and in the preparation of intrinsically conducting polymers [9] and nanoparticles [10], thermochromic dyes [11], light emitting electrochemical cells [12], lithium ion batteries [13], dye-sensitised solar cells [14, 15] and supercapacitors [16].

In particular in the case of electrolyte layers in fuel cells [17], metal-air batteries [18] and humidity sensors [19], good ionic conductivity at elevated temperatures and humidity is highly sought after (the current industrial benchmark, Nafion™, starts to significantly lose ionic conductivity above 90° C. [20]). However, previously reported poly(ionic liquid)s have tended to suffer from poor ionic conductivity compared to their parent monomers, which has been attributed primarily to a lack of polymer chain flexibility [21, 22]. This is normally redressed by doping with ionic liquids or other electrolytes [23], but often at the cost of worsening mechanical properties [24].

The manufacture of such poly(ionic liquid)s typically employs wet chemical approaches, which have inherent disadvantages, including the need for solvent extraction and a separate casting step.

It is an aim of the present invention to provide a new method for the production of poly(ionic liquid)s, which method can overcome or at least mitigate the above described problems. In particular, the invention is based on the finding that poly(ionic liquid)s can be produced using an alternative technique, plasma deposition, and that the resultant polymers can exhibit good ionic conductivity.

### STATEMENTS OF THE INVENTION

According to a first aspect of the present invention there is provided a method for the production of a poly(ionic liquid), which method comprises the steps of:
(i) providing a monomer (I) which comprises both a polymerisable functional group and a nitrogen centre;
(ii) providing a substrate;
(iii) contacting the substrate with the monomer (I) in an exciting medium, in order to cause polymerisation of the monomer and deposition of the resultant precursor polymer (II) on the substrate; and
(iv) subsequently contacting the precursor polymer (II) with a cation-generating agent, in order to convert it into a poly(ionic liquid) (III) containing an imidazolium cation.

Thus, according to the invention, a polymeric precursor (II) to the poly(ionic liquid) (III) is deposited onto the substrate during step (iii). The precursor (II) contains a nitrogen centre, which can subsequently be converted to result in an imidazolium cation, in order to generate the desired poly(ionic liquid) (III).

A “nitrogen-centred cationic moiety” means a moiety in which a nitrogen atom carries a positive charge.

The nitrogen centre may for example be part of a secondary or tertiary amine moiety. In an embodiment, it is part of a tertiary amine moiety.

The ultimate product of the invented method is, effectively, a polymer of a compound containing cationic nitrogen-centred moieties (in particular quaternary or protonated amine moieties), which compound would, in monomeric form, be an ionic liquid. In the context of the present invention, the term “ionic liquid” means a compound comprising ionic moieties, which is capable of existing in liquid form at and below 50° C., preferably at and below 40° C., more preferably at and below 30° C. and ideally at room temperature, which for the present purposes may be defined as from 18 to 25° C., typically about 20° C.

It has been found that a poly(ionic liquid) prepared according to the invention can have superior ionic conductivity, compared for example to poly(ionic liquid)s prepared in more conventional ways such as using wet chemical techniques. Moreover, such properties can be obtained without the need for doping of the polymer with other conducting species such as ionic liquid monomers or electrolytes, which could otherwise add to the cost and complexity of the production process, and/or compromise the properties and performance of the polymer, in particular its mechanical strength.

According to the invention, the poly(ionic liquid) precursor (II) is formed on the substrate using an exciting medium, in particular by plasma deposition. The exciting medium may for instance be generated using a hot filament, ultraviolet radiation, gamma radiation, ion irradiation, an electron beam, laser radiation, infrared radiation, microwave radiation, or any combination thereof. In general terms it may be created using a flux of electromagnetic radiation, and/or a flux of ionised particles and/or radicals.

In an embodiment, the exciting medium is a plasma. Plasma (or plasmachemical) deposition processes can provide a solventless approach to the preparation of well-defined polymer films; they involve the deposition of a monomer (polymer precursor) onto a substrate within an exciting medium such as a plasma, which causes the precursor molecules to polymerise as they are deposited. Plasma-activated polymer deposition processes have been widely documented in the past—see for example J P S Badyal, Chemistry in Britain 37 (2001): 45-46.

A plasma deposition process may be carried out in the gas phase, typically under sub-atmospheric conditions, or on a liquid monomer or monomer-carrying vehicle as in the atomised liquid spray deposition process described in WO-03/101621.

Such deposition processes have in the past been used to prepare polymers which are subsequently doped with ionic liquids [Izgorodin, A; Winther-Jensen, O; Winther-Jensen, B; MacFarlane, D R, Phys Chem Chem Phys, 2009, 11: 8532]. However, they have not to our knowledge been used to prepare a poly(ionic liquid) directly on a substrate.

In an embodiment, the poly(ionic liquid) precursor (II) is applied to the substrate using a pulsed excitation and deposition process. In other words, the substrate is contacted with the monomer (I) in a pulsed exciting medium, in particular a pulsed plasma.

Pulsed plasmachemical deposition typically entails modulating an electrical discharge on the microsecond-millisecond timescale in the presence of a suitable monomer in vapour form, thereby triggering monomer activation and reactive site generation at the surface (via VUV irradiation, and/or ion and/or electron bombardment) during each short (typically microsecond) duty cycle on-period. This is followed by conventional polymerisation of the monomer during each relatively long (typically millisecond) off-period.

Pulsed plasma deposition can result in polymeric layers which retain a high proportion of the original functional moieties; past examples have included anhydride [25, 26, 27], carboxylic acid [28], amine [29], cyano [30], epoxide [31, 32], hydroxyl [33], halide [34], thiol [35], furfuryl [36], perfluoroalkyl [37], perfluoromethylene [38] and trifluoromethyl [39] groups. Other previous examples of pulsed plasma deposited functional films include poly(glycidyl methacrylate), poly(bromoethyl-acrylate), poly(vinyl aniline), poly(vinylbenzyl chloride), poly(allylmercaptan), poly(N-acryloylsarcosine methyl ester), poly(4-vinyl pyridine) and poly(hydroxyethyl methacrylate).

The advantages of using (pulsed) plasma deposition, in order to deposit the poly(ionic liquid) precursor polymer (II), can include the potential applicability of the technique to a wide range of substrate materials and geometries, with the resulting deposited layer conforming well to the underlying surface. The technique can provide a straightforward and effective method for functionalising solid surfaces, being a single step, solventless and substrate-independent process. The inherent reactive nature of the electrical discharge can ensure good adhesion to the substrate via free radical sites created at the interface during ignition of the exciting medium. Moreover during pulsed plasma deposition, the level of surface functionality can be tailored by adjusting the plasma duty cycle.

A polymer which has been applied to a substrate using plasma deposition will typically exhibit good adhesion to the substrate surface. The applied polymer will typically form as a uniform conformal coating over the entire area of the substrate which is exposed to the relevant monomer during the deposition process, regardless of substrate geometry or surface morphology. Such a polymer will also typically exhibit a high level of structural retention of the relevant monomer, particularly when the polymer has been deposited at relatively high flow rates and/or low average powers such as can be achieved using pulsed plasma deposition or atomised liquid spray plasma deposition.

The monomer (I) incorporates a nitrogen centre which, when contacted with the cation-generating agent, will result in an imidazolium cation.

In an embodiment, the nitrogen centre is part of a nitrogen-containing ring, which may be an aromatic ring. In an embodiment, the monomer (I) incorporates a nitrogen centre which is part of an imidazole group.

In a specific embodiment, the monomer (I) incorporates an imidazole group. It may thus be a substituted imidazole, for example an allyl-substituted imidazole.

The monomer (I) also incorporates a polymerisable functional group. Such a group may for example include a carbon-carbon double bond; it may thus comprise a vinyl group. Examples of suitable polymerisable functional groups include vinyl and allyl groups; acrylamide and alkylacrylamide (for example methylacrylamide or dimethylacrylamide) groups; and acrylate and alkylacrylate (for example methacrylate) groups. In an embodiment, the polymerisable functional group in the monomer (I) is an allyl group.

Where the monomer (I) incorporates an imidazole group, the polymerisable functional group may be attached to one of the nitrogen atoms in the imidazole ring, and may in particular comprise an allyl group.

In an embodiment, the polymerisable functional group is not attached to the nitrogen centre which is subsequently converted to a cationic moiety.

In a specific embodiment, the monomer (I) is selected from N-allylimidazole and substituted forms thereof. A substituted N-allylimidazole may in particular be substituted with one or more (suitably one) alkyl groups, which may be selected from C1 to C4 or C1 to C3 or C1 to C2 alkyl groups, for example as in 1-allyl-2-methylimidazole. In an embodiment, the monomer (I) is unsubstituted N-allylimidazole.

In a method according to the invention, the substrate may be formed of any suitable material (typically a solid), depending on its intended use. In an embodiment, the substrate is an electronically conducting substrate, for example selected from graphite, carbon cloth, carbon black, metallic or metal-containing electronically conducting substrates such as indium tin oxide, and combinations thereof. Other potential substrates include structural polymers such as polypropylene; glass; silicon and silicon derivatives; and combinations thereof. The substrate may be any object to which an ionically conductive coating is to be applied, including a thin substrate or film which is itself suitable and/or adapted and/or intended to be applied to the surface of another object.

The precursor polymer (II) may be deposited on the substrate in the form of a layer (which includes a film) of any desired thickness. This layer may for instance have a thickness of 5 nm or greater, for example of 50 or 500 nm or greater, or of 1 μm or greater. It may for instance have a thickness of up to 100 μm, for example of up to 50 or 10 μm, such as from 5 nm to 100 μm or from 0.5 to 10 μm.

Any suitable conditions may be employed for the deposition step (iii) of the invented method, depending on the nature of the monomer (I) and of the coating needed on the substrate. The deposition is suitably carried out in the vapour phase. By way of example, and in particular when the exciting medium is a pulsed plasma and/or when the monomer (I) is an imidazole such as 1-allylimidazole, one or more of the following conditions may be used:
a. a pressure of from 0.01 mbar to 1 bar, for example from 0.01 or 0.1 mbar to 1 mbar or from 0.1 to 0.5 mbar, such as about 0.18 mbar.
b. a temperature of from 0 to 300° C., for example from 10 or 15 to 70° C. or from 15 to 30° C., such as room temperature (which may be from about 18 to 25° C., such as about 20° C.).
c. a power (or in the case of a pulsed exciting medium, a peak power) of from 1 to 500 W, for example from 5 to 70 W or from 5 to 50 W, such as about 30 W.
d. in the case of a pulsed exciting medium (for example a pulsed plasma), a duty cycle on-period of from 1 to 5,000 μs, for example from 1 to 500 or from 5 to 500 or from 5 to 100 μs or from 5 to 50 μs, such as about 20 μs.
e. in the case of a pulsed exciting medium (for example a pulsed plasma), a duty cycle off-period of from 1 to 100,000 μs, for example from 1,000 to 20,000 μs or from 1,000 to 10,000 or 1,000 to 5,000 or 1,000 to 2,000 μs, such as about 1200 μs.
f. in the case of a pulsed exciting medium (for example a pulsed plasma), a ratio of duty cycle on-period to off-period of from 0.001 to 1, for example from 0.01 to 0.5 or from 0.01 to 0.05 or from 0.01 to 0.02, such as about 0.0167.

In the case of a pulsed exciting medium such as a pulsed plasma, conditions (d) and (f) may be particularly preferred. More particularly, it may be preferred to use a duty cycle on-period of from 1 to 500 or from 1 to 100 μs, and/or a ratio of duty cycle on-period to off-period of from 0.001 to 0.5 or from 0.001 to 0.1 or from 0.001 to 0.05.

In an embodiment of the invention, the cation-generating agent used in step (iv) is a quaternising or protonating agent. In an embodiment, it is an electrophilic species. In an embodiment, it is a quaternising agent. It may in particular be an alkylating agent, which is capable of alkylating the nitrogen centre in order to convert it into a cationic centre. Such an alkylating agent may for example have the formula R-L, where R is an optionally substituted alkyl group and L is a leaving group. Suitable leaving groups L may be selected from halo groups (for example fluoro, chloro or bromo, in particular chloro or bromo, more particularly bromo); carboxylate groups; sulphonates; phosphonates; tosylate; and triflate.

In the present context, an alkyl group may be either linear or branched, in particular linear. In an embodiment it is a C1 to C6 alkyl group, or a C1 to C4 alkyl group, for example n-butyl.

An optionally substituted alkyl group may be substituted with one or more further groups. Such groups may be selected from alkyl (in particular C1 to C4 or C1 to C3 or C1 to C2 alkyl); alkenyl (in particular C2 to C4 or C2 to C3 alkenyl); hydroxyl; alkoxyl (in particular C1 to C4 or C1 to C3 or C1 to C2 alkoxyl); carboxyl; carboxylic acid; amino (in particular primary amino); and aryl (in particular phenyl) groups. Thus, an optionally substituted alkyl group may be an aryl-alkyl group such as benzyl.

In a specific embodiment, a quaternising agent used in step (iv) of the invented method is a haloalkane, in particular a bromoalkane, for example a bromobutane. It may for instance be 1-bromobutane.

A protonating agent used in step (iv) may be a Brønsted acid, which is capable of protonating the nitrogen centre in order to produce a protic poly(ionic liquid). Examples of acids which could be used in this way include but are not limited to carboxylic acids (including, for example, trifluoroacetic acid); sulphonic acids such as sulphuric or triflic acids; phosphonic acids such as phosphoric acid; and nitric acid.

In an embodiment of the invention, a quaternising or protonating agent is used in step (iv). In an embodiment, a quaternising agent is used in step (iv).

Step (iv), which involves the generation of a nitrogen-centred cation in the precursor (II), is suitably carried out in the vapour phase. It may for instance be carried out at a temperature from 0 to 200° C., for example from 50 to 100° C., such as about 70° C. It may be carried out at a pressure from 0.01 to 5,000 mbar, for example from 0.1 to 1,000 mbar or from 0.1 to 100 mbar or from 1 to 10 mbar, such as about 4 mbar.

The cation-generating step (iv) suitably results in a polymer in which the imidazolium cations are present on polymer side chains. Thus, the monomer (I) may be chosen such that the nitrogen centres will be present on polymer side chains in the precursor polymer (II).

The method of the invention may involve copolymerising two or more different monomers (I) onto the substrate during step (iii). It may involve copolymerising the monomer (I) with another polymerisable monomer, for example in order to generate a polymer which contains both poly(ionic liquid) moieties and other forms of functionality.

According to a second aspect, the present invention provides a poly(ionic liquid) which has been produced using a method according to the first aspect. Such a polymer is typically present in the form of a coating on a substrate.

The poly(ionic liquid) incorporates an imidazolium cation such as an N-alkyl imidazolium cation. It suitably incorporates imidazolium cations which are present on polymer side chains.

In an embodiment, a poly(ionic liquid) according to the invention has an ionic conductivity of 0.01 mS cm⁻¹ or greater, for example of 0.1 mS cm⁻¹ or greater, or of 0.5 or 0.6 mS cm⁻¹ or greater: such conductivities may be measured at room temperature and a relative humidity of from 70 to 80%, such as about 75%. At room temperature and a relative humidity of 90 or 95% or greater (such as about 97%), the poly(ionic liquid) may have an ionic conductivity of 0.01 mS cm⁻¹ or greater, for example of 0.1 or 0.5 mS cm⁻¹ or greater, or of 0.8 or 0.9 mS cm⁻¹ or greater. At temperatures of 50° C. or higher, such as about 60° C., and a relative humidity of from 70 to 80% (such as about 75%), the poly(ionic liquid) may have an ionic conductivity of 0.1 mS cm⁻¹ or greater, for example of 1 mS cm⁻¹ or greater, or of 5 or 6 or 6.5 mS cm⁻¹ or greater. At temperatures of 75° C. or higher, such as about 80° C., and a relative humidity of from 70 to 80% (such as about 75%), the poly(ionic liquid) may have an ionic conductivity of 0.1 mS cm⁻¹ or greater, for example of 1 or 5 or 10 mS cm⁻¹ or greater, or of 12 mS cm⁻¹ or greater.

At temperatures of 90° C. or higher, such as about 100° C., and a relative humidity of from 70 to 80% (such as about 75%), the poly(ionic liquid) may have an ionic conductivity of 1 mS cm⁻¹ or greater, for example of 10 or 25 or 50 or 75 mS cm⁻¹ or greater, or of 80 or 90 mS cm⁻¹ or greater.

Suitably, the poly(ionic liquid) has this degree of ionic conductivity in the absence of doping agents such as ionic liquid monomers, electrolytes, metal salts or acids. Thus, a poly(ionic liquid) according to the invention suitably contains no, or less than 10% w/w of, or less than 5 or 2 or 1 or 0.5% w/w of, doping agents such as ionic liquid monomers, electrolytes, metal salts or acids.

A third aspect of the invention provides a precursor polymer (II) produced during step (iii) of a method according to the first aspect. Again, such a polymer is typically present in the form of a coating on a substrate.

The precursor polymer (II) contains a nitrogen centre, and can subsequently be converted, using a suitable cation-generating agent, into a poly(ionic liquid) according to the second aspect of the invention.

As discussed above, a poly(ionic liquid) or precursor polymer (II) produced using the method of the first aspect of the invention may be a copolymer which incorporates one or more other monomers in addition to the monomer (I). In an embodiment, however, a poly(ionic liquid) according to the second aspect of the invention does not incorporate monomers other than the monomer (I). In an embodiment, a precursor polymer (II) according to the third aspect of the invention does not incorporate monomers other than the monomer (I).

According to a fourth aspect of the invention, there is provided a product which is formed from or incorporates a poly(ionic liquid) according to the second aspect of the invention. The product may for example comprise an electrochemical device or a component for use in such a device, in particular an electrochemical cell or a device including an electrochemical cell; a photovoltaic cell; a humidity sensor; or a device for use in chromatography or another separation technique.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property, for example a temperature or pressure or conductivity, then a range of values defined by a combination of any of the upper limits with any of the lower limits may also be implied.

The present invention will now be further described with reference to the following non-limiting examples and the accompanying figures, of which:

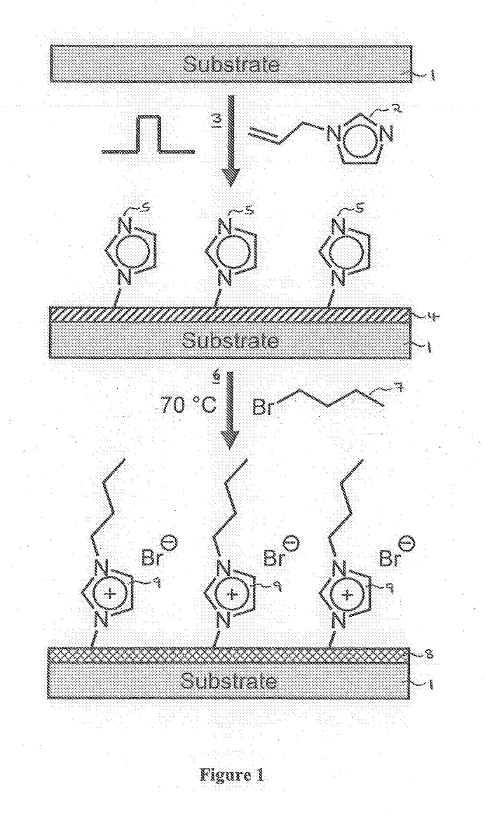

FIG. 1 shows schematically a method in accordance with the invention;

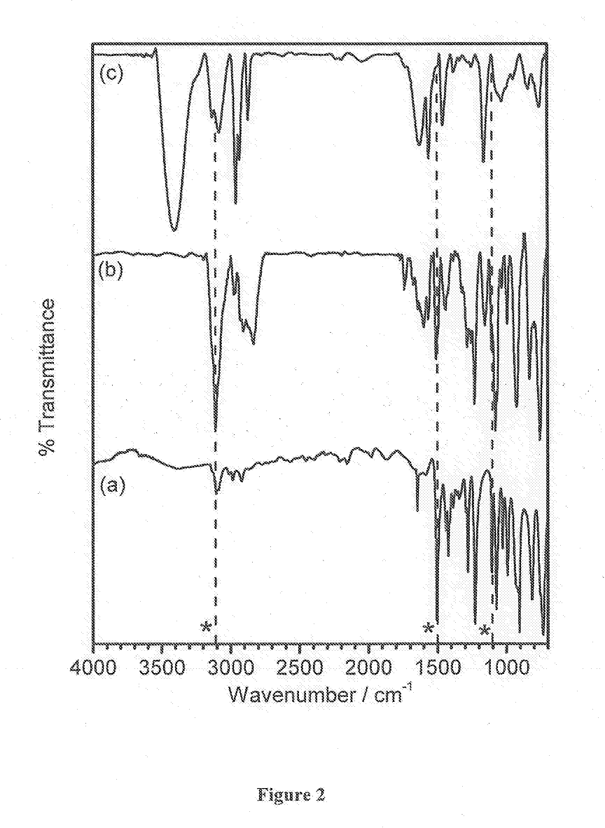

FIG. 2 shows Fourier transform infrared spectra for materials used and produced in Example 1 below;

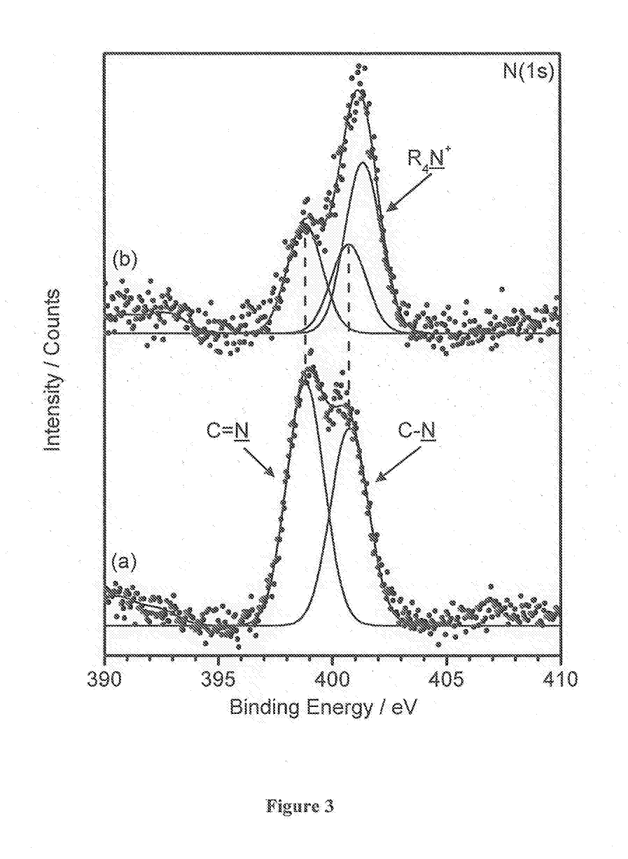

FIG. 3 shows X-ray photoelectron spectra for polymers produced in Example 1; and

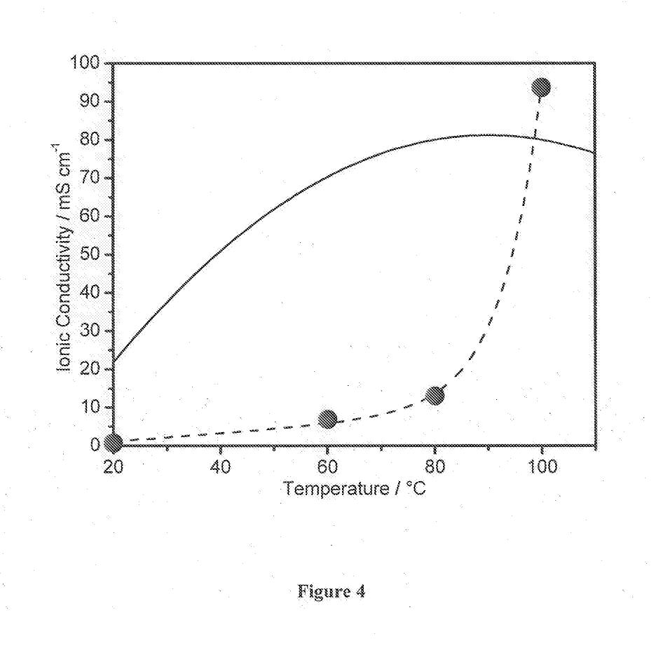

FIG. 4 shows the ionic conductivities of the Example 1 polymer and a commercially available ionic polymer, at 75% relative humidity and a range of temperatures.

### DETAILED DESCRIPTION

### The FIG. 1 Scheme

FIG. 1 shows how, in accordance with the invention, a substrate 1 can be coated with a poly(ionic liquid) in the form of a poly(N-butyl imidazolium) compound.

The monomer (I) is in this case 1-allylimidazole 2. Using a pulsed plasma to excite this monomer, as indicated by the arrow 3, results in deposition of a poly(1-allylimidazole) film 4 on the substrate 1; this corresponds to the precursor polymer (II) in the invented method. The polymer 4 carries pendant imidazole groups, each of which comprises a tertiary amine moiety 5.

The polymer film 4 is then quaternised, as indicated by the arrow 6, using 1-bromobutane 7 in the vapour phase, for example at 70° C. This results in a poly(ionic liquid) film 8, which now carries pendant imidazolium moieties 9. The pendant imidazolium cations, and their associated bromide anions, provide a high degree of ionic conductivity in the film 8.

It can be seen that the invented method can provide a simple, two-step process for preparing a poly(ionic liquid), which can yield a highly conductive product without the need for further doping agents. The use of plasma deposition to prepare the precursor polymer 4 can allow the generation of a high quality polymer coating with good structural retention, and with good surface uniformity. It can also allow the coating of a wide range of substrate materials and geometries, with good surface conformity.

In the example below, a polymer-coated substrate was prepared according to the FIG. 1 scheme, using 1-allylimidazole as the monomer (I) and 1-bromobutane as the quaternising agent. The structure and properties of the thus-deposited polymer were characterised by Fourier transform infrared (FTIR) spectroscopy, X-ray photoelectron spectroscopy and electrochemical impedance spectroscopy.

### Example 1

### 1 Experimental

### 1.1 Plasma Deposition of Poly(1-Allylimidazole) Films

Plasma deposition was carried out in an electrodeless cylindrical glass reactor (volume of 480 cm³, base pressure of 3×10⁻³ mbar, and with a leak rate better than 2×10⁻⁹ mol s⁻¹), surrounded by a copper coil (4 mm diameter, 10 turns) and enclosed in a Faraday cage. The reactor was pumped down using a 30 L min⁻¹ rotary pump attached to a liquid nitrogen cold trap; a Pirani gauge was used to monitor system pressure. The output impedance of a 13.56 MHz radio frequency (rf) power supply was matched to the partially ionised gas load via an L-C circuit.

Prior to each deposition, the reactor was scrubbed using detergent, rinsed in propan-2-ol, and dried in an oven. A continuous wave air plasma was then run at 0.2 mbar pressure and 40 W power for 30 minutes, in order to remove any remaining trace contaminants from the reactor walls.

The substrates used for coating were silicon (100) wafer pieces (Silicon Valley Microelectronics Inc) and polypropylene sheet pieces (Lawson Mardon Ltd), with two evaporated gold electrodes (5 mm length and 1.5 mm separation) for proton conductivity testing.

1-Allylimidazole (+97%, Acros Organics Ltd) was loaded into a sealable glass tube and degassed using several freeze-pump-thaw cycles. Monomer vapour was allowed to purge the reactor for 5 minutes at a pressure of 0.18 mbar prior to electrical discharge ignition. Pulsed plasma deposition utilised an optimal duty cycle of 20 μs on-period and 1200 μs off-period in conjunction with a peak power of 30 W; a polymer deposition rate of 14 nm/min was achieved. Upon plasma extinction, the monomer vapour was allowed to continue to pass through the system for a further 3 minutes, and then the reactor was evacuated back down to base pressure.

In order to effect quaternisation of the surface coatings, the reactor was heated to 70° C. and 1-bromobutane vapour (99%, Sigma-Aldrich Ltd, degassed using several freeze-pump-thaw cycles) was introduced at a pressure of 4 mbar for up to 4.5 hours. After this, the reactor was again evacuated to base pressure before venting to atmosphere.

### 1.2 Film Characterisation

Infrared spectra were acquired using an FTIR spectrometer (Perkin-Elmer Spectrum One™) fitted with a liquid nitrogen cooled MCT detector operating at 4 cm⁻¹ resolution across the 700-4000 cm⁻¹ range. The instrument included a variable angle reflection-absorption accessory (Specac™) set to a grazing angle of 66° for silicon wafer substrates and adjusted for p-polarisation.

Surface elemental compositions were determined by X-ray photoelectron spectroscopy (XPS) using a VG ESCALAB™ II electron spectrometer equipped with a non-monochromated Mg Kα X-ray source (1253.6 eV) and a concentric hemispherical analyser. Photoemitted electrons were collected at a take-off angle of 20° from the substrate normal, with electron detection in the constant analyser energy mode (CAE, pass energy=20 eV). Experimentally determined instrument sensitivity factors were taken as C(1s):N(1s):Br(3d) equals 1.00:0.66:0.36. All binding energies were referenced to the C(1s) hydrocarbon peak at 285.0 eV. A linear background was subtracted from core level spectra and then fitted using Gaussian peak shapes with a constant full-width-half-maximum (fwhm) [49].

Film thicknesses were measured using a spectrophotometer (nkd-6000, Aquila Instruments Ltd). Transmittance-reflectance curves (350-1000 nm wavelength range) were acquired for each sample and fitted to a Cauchy material model using a modified Levenberg-Marquardt algorithm [50].

Impedance measurements across the 10 Hz-13 MHz frequency range were carried out using an LF impedance analyser (Hewlett-Packard, 4192A) for coated polypropylene substrates. The low frequency 45° line in the acquired impedance plots was assigned to the Warburg diffusion impedance, and a high frequency arc was fitted in order to extract the resistance of the deposited membrane layer [51]. The formula σ=1/RSA was used to calculate proton conductivity, where σ is the membrane conductivity, RS is the bulk membrane resistance, l is the length of the electrodes, and A is the cross-sectional area of the film [52]. Humidities of 97% and 75% were achieved by using, respectively, saturated solutions of potassium sulphate (+99%, Sigma-Aldrich Ltd) and sodium chloride (+99.5%, Sigma-Aldrich Ltd) in water [53].

For measurements at elevated temperatures, the cell was run in a potentiostatic mode (Bio-Logic™ SP-150) by applying a sinusoidal AC potential around applied DC potentials of 0.3 V, 0.5 V and 0.7 V respectively.

### 2 Results

### 2.1 Introduction

This example shows how pulsed plasmachemical deposition can be used to produce thin films containing a high density of imidazole groups, which can subsequently be quaternised using vapour-phase reaction with bromobutane, as shown in FIG. 1. The resultant films were found to have unexpectedly high ionic conductivities, up to 93.6 mS cm⁻¹ at 100° C.: this is comparable to the conductivity of the widely cited benchmark, Nafion™, which is a sulphonated tetrafluoroethylene-based synthetic copolymer with ionic properties, used as a proton conductor for example in proton exchange membrane fuel cells (see 2.3 below).

### 2.2 Structural Analyses

Fourier transform infrared (FTIR) spectroscopy of the pulsed plasma deposited poly(1-allylimidazole) films showed good structural retention when compared to the imidazole monomer. FIG. 2 shows the FTIR spectra of (a) the 1-allylimidazole monomer; (b) the pulsed plasma deposited poly(1-allylimidazole); and (c) the final quaternised poly(ionic liquid) product.

Imidazole ring stretches (denoted by * in FIG. 2) could be seen in both the monomer and the deposited films, including a C═C—H ring stretch at 3107 cm⁻¹, a C═N ring stretch at 1504 cm⁻¹, and an in-plane bend N═C—H ring vibration at 1107 cm⁻¹ [41, 42]. Upon quaternisation of the imidazole ring with vapour-phase bromobutane, a shift was observed in the imidazole ring vibrations to 3133 cm⁻¹, 1561 cm⁻¹, and 1162 cm⁻¹ respectively, which is consistent with the formation of an imidazolium cation [43]. The appearance of C—H stretches at 2960 cm⁻¹, 2935 cm⁻¹ and 2873 cm⁻¹, along with the out-of-plane HCH deformation at 1463 cm⁻¹, corresponded to the butyl chain. Broad peaks at 3500-3100 cm⁻¹ and 1630 cm⁻¹ for both films were attributed to water stretches, which is consistent with the hydrophilic nature of imidazole-based polymers [41]. Compared to previous pulsed plasma deposited poly(1-allylimidazole) films [41], there was an absence of C≡N stretches at 2230 cm⁻¹, which can be attributed to the milder duty cycle employed in this example.

X-ray photoelectron spectroscopy (XPS) analysis of the plasma deposited poly(1-allylimidazole) layer showed two N(1s) peaks at 398.9 eV and 400.7 eV, respectively corresponding to N—C and N═C centres [44]. FIG. 3 shows the XPS N(1s) spectra of (a) the pulsed plasma deposited poly(1-allylimidazole) and (b) the final, quaternised, polymer. It can be seen that following quaternisation of the imidazole ring, the XPS N(1s) spectrum showed a new, larger peak at 401.4 eV, which denotes quaternised, positively charged nitrogen centres [44]. The XPS ratio of bromine to nitrogen was measured to be 1:3.1, which corresponds to 65% of the imidazole rings being quaternised to imidazolium ions.

Vapour-phase bromobutane quaternisation also caused the film thicknesses (initially around 950 nm) to swell by approximately 10%. This, along with the infrared data, indicates reaction throughout the plasma deposited polymer films.

### 2.3 Conductivity Measurements

Electrochemical impedance spectroscopy was used to measure the ionic conductivity of the deposited polymer films. Measurements at 60, 80 and 100° C. were conducted by IRD Fuel Cells A/S (Svendborg, Denmark).

Control samples of pulsed plasma deposited poly(1-allylimidazole) showed no ionic conductivity, regardless of conditions. In contrast, at room temperature (20° C.), the quaternised poly(imidazolium) films showed ionic conductivity of 0.7 mS cm⁻¹ at 75.5% relative humidity, which increased to 1.0 mS cm⁻¹ at 97.6% relative humidity. This rise in ionic conductivity with relative humidity is similar to that reported for imidazolium-based ionic liquids [45]. At higher temperatures of 60° C. and 80° C., and 75% relative humidity, the ionic conductivity increased further to 6.9 mS cm⁻¹ and 13.0 mS cm⁻¹ respectively.

Upon increasing the temperature to 100° C. (relative humidity still 75%), there was a sharp increase in the ionic conductivity of the films to 93.6 mS cm⁻¹, which is comparable to the performance of Nafion™ films under the same conditions. FIG. 4 compares the ionic conductivities of the Example 1 polymer and Nafion™ at 75% relative humidity and a range of temperatures. The figures for Nafion™ are extrapolated from references [40, 46, 47 and 48].

### 3 Conclusions

This is believed to be the first time that poly(ionic liquid) coatings have been manufactured by a vapour phase plasma deposition technique. The resultant polymer films can show high ionic conductivities, in this case exceeding 90 mS cm⁻¹ at 100° C. and 75% relative humidity. Plasma deposition of the precursor polymer (II), along with vapour phase cation generation (eg quaternisation), can provide a conformal, solventless technique which in principle could be applied directly to a wide range of components, in particular to components for use in electrochemical devices.

### REFERENCES

[1] H. Zheng, H. Zhang, Y. Fu, T. Abe and Z. Ogumi, J. Phys. Chem. B, 2005, 109, 13676.
[2] W. Lu, A. G. Fadeev, B. Qi, E. Smela, B. R. Mattes, J. Ding, G. M. Spinks, J. Mazurkiewicz, D. Zhou, G. G. Wallace, D. R. MacFarlane, S. A. Forsyth and M. Forsyth, Science, 2002, 297, 983.
[3] F. O. Laforge, T. Kakiuchi, F. Shigematsu and M. V. Mirkin, J. Am. Chem. Soc., 2004, 126, 15380.
[4] M. D. Green, C. Schreiner and T. E. Long, J. Phys. Chem. A, 2011, 115, 13829.
[5] J. Huang and I. Sun, Chem. Mater., 2004, 16, 1829.
[6] A.-L. Pont, R. Marcilla, I. De Meatza, H. Grande and D. Mecerreyes, J. Power Sources, 2009, 188, 558.
[7] J. L. Anderson and D. W. Armstrong, Anal. Chem., 2005, 77, 6453.
[8] J. E. Bara, S. Lessmann, C. J. Gabriel, E. S. Hatakeyama, R. D. Noble and D. L. Gin, Ind. Eng. Chem. Res., 2007, 46, 5397.
[9] J. Tang, W. Sun, H. Tang, M. Radosz and Y. Shen, Macromolecules, 2005, 38, 2037.
[10] R. Marcilla, E. Ochoteco, C. Pozo-Gonzalo, H. Grande, J. A. Pomposo and D. Mecerreyes, Macromol. Rapid Commun., 2005, 26, 1122.
[11] X.-D. Mu, J.-Q. Meng, Z.-C. Li and Y. Kou, J. Am. Chem. Soc., 2005, 127, 9694.
[12] C. M. Tollan, R. Marcilla, J. A. Pomposo, J. Rodriguez, J. Aizpurua, J. Molina and D. Mecerreyes, ACS Appl. Mater. Interfaces, 2009, 1, 348.
[13] R. Marcilla, D. Mecerreyes, G. Winroth, S. Brovelli, M. del Mar Rodriguez Yebra and F. Cacialli, Appl. Phys. Lett., 2010, 96, 043308.
[14] R. Kawano, T. Katakabe, H. Shimosawa, Md. K. Nazeeruddin, M. Grätzel, H. Matsui, T. Kitamura, N. Tanabe and M. Watanabe, Phys. Chem. Chem. Phys., 2010, 12, 1916.
[15] G. Wang, L. Wang, S. Zhuo, S. Fang and Y. Lin, Chem. Commun., 2011, 47, 2700.
[16] T. Y. Kim, H. W. Lee, M. Stoller, D. R. Dreyer, C. W. Bielawski, R. S. Ruoff and K. S. Suh, ACS Nano, 2011, 5, 436.
[17] A. Noda, Md. A. Bin Hasan Susan, K. Kudo, S. Mitsushima, K. Hayamizu and M. Watanabe, J. Phys. Chem. B, 2003, 107, 4024.
[18] T. Kuboki, T. Okuyama, T. Ohsaki and N. Takami, J. Power Sources, 2005, 146, 766.
[19] C.-D. Feng, S.-L. Sun, H. Wang, C. U. Segre and J. R. Stetter, Sens. Actuators, B, 1997, 40, 217.
[20] Y.-T. Kim, M.-K. Song, K.-H. Kim, S.-B. Park, S.-K. Min and H.-W. Rhee, Electrochim. Acta, 2004, 50, 645.
[21] Ohno, H. and Yoshizawa, M., ACS Symp. Ser., 2003, 902, 159.
[22] M. Lee, U. H. Choi, R. H. Colby and H. W. Gibson, Chem. Mater., 2010, 22, 5814.
[23] N. Matsumi, K. Sugai, M. Miyake and H. Ohno, Macromolecules, 2006, 39, 6924.
[24] R. Marcilla, F. Alcaide, H. Sardon, J. A. Pomposo, C. Pozo-Gonzalo and D. Mecerreyes, Electrochem. Commun., 2006, 8, 482.
[25] M. E. Ryan, A. M. Hynes and J. P. S. Badyal, Chem. Mater., 1996, 8, 37.
[26] T. J. Wood, W. C. E. Schofield and J. P. S. Badyal, J. Mater. Chem., 2012, 22, 7831.
[27] T. J. Wood and J. P. S. Badyal, ACS Appl. Mater. Interfaces, 2012, 4, 1675.
[28] S. J. Hutton, J. M. Crowther and J. P. S. Badyal, Chem. Mater., 2000, 12, 2282.
[29] L. G. Harris, W. C. E. Schofield, K. J. Doores, B. G. Davis and J. P. S. Badyal, J. Am. Chem. Soc., 2009, 131, 7755.
[30] C. Tarducci, W. C. E. Schofield, J. P. S. Badyal, S. A. Brewer and C. Willis, Chem. Mater., 2001, 13, 1800.
[31] C. Tarducci, W. C. E. Schofield, J. P. S. Badyal, S. A. Brewer and C. Willis, Chem. Mater., 2000, 12, 1884.
[32] P. S. Brown, T. J. Wood, W. C. E. Schofield and J. P. S. Badyal, ACS Appl. Mater. Interfaces, 2011, 3, 1204.
[33] C. Tarducci, W. C. E. Schofield, J. P. S. Badyal, S. A. Brewer and C. Willis, C. Chem. Mater., 2002, 14, 2541.
[34] D. O. H. Teare, D. C. Barwick, W. C. E. Schofield, R. P. Garrod, L. J. Ward and J. P. S. Badyal, Langmuir, 2005, 21, 11425.
[35] W. C. E. Schofield, J. McGettrick, T. J. Bradley, S. Przyborski and J. P. S. Badyal, J. Am. Chem. Soc., 2006, 128, 2280.
[36] C. Tarducci, S. A. Brewer, C. Willis and J. P. S. Badyal, Chem. Commun., 2005, 406.
[37] S. R. Coulson, I. S. Woodward, J. P. S. Badyal, S. A. Brewer and C. Willis, Chem. Mater 2000, 12, 2031.
[38] S. J. Limb, K. K. Gleason, D. J. Edell and E. F. Gleason, J. Vac. Sci. Technol., 1997, A15, 1814.
[39] J.-H. Wang, J.-J. Chen and R. B. Timmons, Chem. Mater., 1996, 8, 2212.
[40] V. Ramani, H. R. Kunz and J. M. Fenton, J. Membr. Sci., 2004, 232, 31.
[41] L. M. Han, R. B. Timmons, D. Bogdal and J. Pielichowski, Chem. Mater., 1998, 10, 1422.
[42] M. Kumagai, K. Tsuchida, Y. Ogino, J. Hansen and H. Ishida, Polymer, 1995, 36, 535.
[43] T. Buffeteau, J. Grondin, Y. Danten and J.-C. Lassègues, J. Phys. Chem. B, 2010, 114, 7587.
[44] G. Beamson and D. Briggs, High Resolution XPS of Organic Polymers, Wiley, Chichester, U.K., 1992.
[45] Y. Ye and Y. A. Elabd, Macromolecules, 2011, 44, 8494.
[46] G. Alberti, U. Costantino, M. Casciola, S. Ferroni, L. Massinelli and P. Staiti, Solid State Ionics, 2001, 145, 249.
[47] F. Bauer and M. Willert-Porada, J. Power Sources, 2005, 145, 101.
[48] F. Mura, R. F. Silva and A. Pozio, Electrochim. Acta, 2007, 52, 5824.
[49] Friedman, R. M.; Hudis, J.; Perlman, M. L. Phys. Rev. Lett. 1972, 29, 692.
[50] Lovering, D. NKD-6000 Technical Manual; Aquila Instruments: Cambridge, U.K., 1998.
[51] Mikhailenko, S. D.; Guiver, M. D.; Kaliaguine, S. Solid State Ionics 2008, 179, 619.
[52] Zawodzinski Jr., T. A.; Neeman, M.; Sillerud, L. O.; Gottesfeld, S. J. Phys. Chem. 1991, 95, 6040.
[53] Rockland, L. B. Anal. Chem. 1960, 32, 1375.

1. A method for the production of a poly(ionic liquid), which method comprises the steps of:
(i) providing a monomer (I) which comprises both a polymerisable functional group and a nitrogen centre;
(ii) providing a substrate;
(iii) contacting the substrate with the monomer (I) in an exciting medium, in order to cause polymerisation of the monomer and deposition of the resultant precursor polymer (II) on the substrate; and
(iv) subsequently contacting the precursor polymer (II) with a cation-generating agent, in order to convert it into a poly(ionic liquid) (III) containing an imidazolium cation.

2. The method according to claim 1, wherein the exciting medium in step (iii) is a plasma.

3. The method according to claim 1, wherein the exciting medium in step (iii) is pulsed.

4. The method according to claim 1, wherein the monomer (I) incorporates an imidazole group.

5. The method according to claim 1, wherein the polymerisable functional group in the monomer (I) is selected from vinyl and allyl groups; acrylamide and alkylacrylamide groups; and acrylate and alkylacrylate groups.

6. The method according to claim 5, wherein the monomer (I) is selected from unsubstituted and alkyl-substituted N-allylimidazoles.

7. The method according to claim 1, wherein the substrate is an electronically conducting substrate.

8. The method according to claim 1, wherein the cation-generating agent used in step (iv) is a quaternising or protonating agent, which is capable of generating respectively a quaternary or a protonated nitrogen-centred cationic moiety.

9. The method according to claim 1, wherein the cation-generating agent used in step (iv) is an alkylating agent, which is capable of alkylating the nitrogen centre in order to convert it into a cationic centre.

10. The method according to claim 1, wherein the cation-generating agent used in step (iv) is a Brønsted acid, which is capable of protonating the nitrogen centre.

11. The method according to claim 1, wherein the cation-generating step (iv) is carried out in the vapour phase.

12. The method according to claim 1, wherein the cation-generating step (iv) results in a polymer in which the imidazolium cations are present on polymer side chains.

13. A poly(ionic liquid) which has been produced using a method according to claim 1.

14. The poly(ionic liquid) according to claim 13, which has an ionic conductivity of 0.01 mS cm⁻¹ or greater, at room temperature and a relative humidity of 75%.

15. The poly(ionic liquid) according to claim 13, which has an ionic conductivity of 0.1 mS cm⁻¹ or greater, at 60° C. and a relative humidity of 75%.

16. The poly(ionic liquid) according to claim 13, which has an ionic conductivity of 1 mS cm⁻¹ or greater, at 100° C. and a relative humidity of 75%.

17. The poly(ionic liquid) according to claim 13, which contains less than 10% w/w of doping agents such as ionic liquid monomers, electrolytes, metal salts or acids.
